(19) United States
(12) Patent Application Publication
(10) Pub. No.: US 2012/0009472 A1
(43) Pub. Date: Jan. 12, 2012

(54) NEGATIVE ELECTRODE FOR NONAQUEOUS ELECTROLYTE SECONDARY BATTERY AND NONAQUEOUS ELECTROLYTE SECONDARY BATTERY

(75) Inventors: Mai Yokoi, Kobe city (JP); Hiroshi Minami, Kobe city (JP); Naoki Imachi, Kobe city (JP)

(73) Assignee: SANYO ELECTRIC CO., LTD., Osaka (JP)

(21) Appl. No.: 13/180,803

(22) Filed: Jul. 12, 2011

(30) Foreign Application Priority Data
Jul. 12, 2010 (JP) 2010-157710

(51) Int. Cl. H01M 4/48; H01M 4/583; H01M 10/052; H01M 4/64

(52) U.S. Cl. 429/211

(57) ABSTRACT

A negative electrode for a nonaqueous electrolyte secondary battery includes a negative-electrode current collector, a first negative-electrode active material layer, and a second negative-electrode active material layer. The first negative-electrode active material layer is formed on the negative-electrode current collector. The first negative-electrode active material layer contains graphite as a first negative-electrode active material. The second negative-electrode active material layer is formed on the first negative-electrode active material layer. The second negative-electrode active material layer contains a lithium titanate composite oxide as a second negative-electrode active material.

### BACKGROUND OF THE INVENTION

1. Field of the Invention

This invention relates to negative electrodes for nonaqueous electrolyte secondary batteries and nonaqueous electrolyte secondary batteries with such negative electrodes.

2. Description of Related Arts

In recent years nonaqueous electrolyte secondary batteries have been used more and more as driving power sources for mobile information terminals, such as cellular phones, notebook computers, and personal digital assistants (PDAs).

Such a nonaqueous electrolyte secondary battery includes: an electrode assembly having a positive electrode, a negative electrode, and a separator; and a nonaqueous electrolyte impregnated into the electrode assembly. A negative-electrode active material commonly used at present for negative electrodes is graphite which requires a low potential for lithium ion insertion and extraction and provides a high-capacity battery (see, for example, JP-A-2010-129192).

### SUMMARY OF THE INVENTION

Meanwhile, nonaqueous electrolyte secondary batteries are required to have not only high capacity and excellent charge-discharge cycle characteristics but also difficulty in being reduced in discharge capacity even in high-temperature atmospheres, that is, excellent high-temperature storage life.

However, nonaqueous electrolyte secondary batteries using graphite as a negative-electrode active material are less likely to provide good enough high-temperature storage life.

The present invention has been made in view of the above points and, therefore, an object thereof is to improve the high-temperature storage life of a nonaqueous electrolyte secondary battery without reducing the capacity.

A negative electrode for a nonaqueous electrolyte secondary battery according to a first aspect of the present invention includes a negative-electrode current collector, a first negative-electrode active material layer, and a second negative-electrode active material layer. The first negative-electrode active material layer is formed on the negative-electrode current collector. The first negative-electrode active material layer contains graphite as a first negative-electrode active material. The second negative-electrode active material layer is formed on the first negative-electrode active material layer. The second negative-electrode active material layer contains a lithium titanate composite oxide as a second negative-electrode active material.

As just described, in this aspect of the present invention, the second negative-electrode active material layer containing a lithium titanate composite oxide as a negative-electrode active material is formed on the first negative-electrode active material layer containing graphite as a negative-electrode active material, such as natural graphite or artificial graphite. Therefore, the resultant nonaqueous electrolyte secondary battery achieves an excellent high-temperature storage life.

This achievement of an excellent high-temperature storage life in this aspect of the present invention can be attributed to the following factors.

First, the reason why the high-temperature storage life is shortened in the case of use of a negative electrode having a single negative-electrode active material layer containing graphite as a negative-electrode active material can be attributed to the fact that a deposit layer is formed on the negative-electrode active material layer to inhibit lithium ions from being inserted into and extracted from the negative-electrode active material layer. More specifically, various materials eluted from the positive electrode into the nonaqueous electrolyte are deposited on the negative-electrode active material layer. As the temperature of the nonaqueous electrolyte secondary battery increases, the amount of materials deposited on the negative-electrode active material layer also increases to form a thicker deposit layer. If a thick deposit layer is formed, it inhibits lithium ions from being inserted into and extracted from the negative-electrode active material layer. As a result, the secondary battery deteriorates the discharge characteristic after being stored in high-temperature atmospheres.

As described above, in this aspect of the present invention, the second negative-electrode active material layer containing a lithium titanate composite oxide as a negative-electrode active material is formed on the first negative-electrode active material layer containing graphite as a negative-electrode active material. Therefore, it is prevented that a deposit layer is formed directly on top of the first negative-electrode active material layer containing graphite as a negative-electrode active material. Hence, the nonaqueous electrolyte secondary battery can achieve an excellent high-temperature storage life.

In this case, a deposit layer builds up on the second negative-electrode active material layer. However, the lithium titanate composite oxide contained as a negative-electrode active material in the second negative-electrode active material layer has no layered structure, unlike graphite, but has an abundance of sites at which lithium ions can be inserted thereinto and extracted therefrom. Therefore, even when a deposit layer is formed on the second negative-electrode active material layer, lithium ions are less likely to be inhibited from being inserted into and extracted from the first negative-electrode active material layer. Thus it can be assumed that even when a deposit layer is formed on the second negative-electrode active material layer, the high-temperature storage life is not reduced so much.

For example, from the viewpoint of providing an excellent high-temperature storage life, it is conceivable to form only a second negative-electrode active material layer containing a lithium titanate composite oxide as a negative-electrode active material on the negative-electrode current collector. However, lithium titanate composite oxides require higher potentials for lithium ion insertion and extraction than graphite. Therefore, the operating potential of the negative electrode becomes higher to reduce the capacity of the resultant nonaqueous electrolyte secondary battery.

In contrast, in this aspect of the present invention, the first negative-electrode active material layer is also formed which contains as a negative-electrode active material graphite requiring a low potential for lithium ion insertion and extraction. This increases the capacity of the nonaqueous electrolyte secondary battery. In other words, in this aspect of the present invention, the high-temperature storage life of the nonaqueous electrolyte secondary battery can be improved without reduction in capacity.

In this aspect of the present invention, the entire first negative-electrode active material layer is not necessarily fully covered with the second negative-electrode active material layer and part of the first negative-electrode active material layer may be exposed from the second negative-electrode active material layer. Of course, from the viewpoint of providing a more excellent high-temperature storage life, it is preferred that the first negative-electrode active material layer be substantially entirely covered with the second negative-electrode active material layer and it is more preferred that the entire first negative-electrode active material layer be fully covered with the second negative-electrode active material layer.

In this aspect of the present invention, as described previously, the second negative-electrode active material layer has the function of preventing formation of a deposit layer directly on top of the first negative-electrode active material layer. Therefore, the second negative-electrode active material layer is not necessarily very thick. Furthermore, if the thickness of the second negative-electrode active material layer is increased while the thickness of the first negative-electrode active material layer is decreased, the content of graphite requiring a low potential for lithium ion insertion and extraction tends to be decreased to reduce the battery capacity. Therefore, the thickness of the first negative-electrode active material layer is preferably greater than that of the second negative-electrode active material layer and more preferably two or more times greater than that of the second negative-electrode active material layer. Moreover, the content of the lithium titanate composite oxide in the total amount of the graphite and the lithium titanate composite oxide ((lithium titanate composite oxide)/(graphite+lithium titanate composite oxide)) is preferably not greater than 10% by mass but not smaller than 1% by mass. More preferably, the content of the lithium titanate composite oxide ((lithium titanate composite oxide)/(graphite+lithium titanate composite oxide)) is not smaller than 5% by mass.

In this aspect of the present invention, the lithium titanate composite oxide used is not particularly limited but is preferably, for example, spinel lithium titanate (Li₄Ti₅O₁₂) having an excellent lithium ion acceptability.

In this aspect of the present invention, the first negative-electrode active material layer may further contain one or more kinds of negative-electrode active materials other than graphite so long as it contains graphite as a main negative-electrode active material. Furthermore, the second negative-electrode active material layer may further contain one or more kinds of negative-electrode active materials other than lithium titanate composite oxides so long as it contains a lithium titanate composite oxide as a main negative-electrode active material.

In this aspect of the present invention, each of the first and second negative-electrode active material layers may contain an electronic conductor, a binder and/or other additives in addition to the negative-electrode active material. If each of the first and second negative-electrode active material layers contains a binder, it is preferred that the respective binders contained in the first and second negative-electrode active material layers be of different types. The reason for this is that if the binders contained in the first and second negative-electrode active material layers were of the same type, in forming the first and second negative-electrode active material layers, each binder might penetrate from the relevant negative-electrode active material layer into the other negative-electrode active material layer. From the viewpoint of effectively preventing penetration of the binders, it is more preferred that the binder contained in the first negative-electrode active material layer and the binder contained in the second negative-electrode active material layer be less compatible. For example, it is preferred that the first negative-electrode active material layer contain a water-based binder and the second negative-electrode active material layer contain a non-water-based binder. Specifically, it is preferred that the first negative-electrode active material layer contain a latex resin as a binder and the second negative-electrode active material layer contain poly(vinylidene fluoride) as a binder.

In this aspect of the present invention, the negative-electrode current collector used is not particularly limited so long as it has electrical conductivity. The negative-electrode current collector can be composed of a piece of electrically conductive metal foil, for example. Specific examples of electrically conductive metal foils include foils made of metals, such as copper, nickel, iron, titan, cobalt, manganese, tin, silicon, chrome, and zirconium, and foils made of alloys containing one or more of these metals. Preferred among them are copper thin film and foils made of alloys containing copper because it is preferred that the electrically conductive metal foil contain a metal element likely to be dispersed into active material particles.

The thickness of the negative-electrode current collector is not particularly limited and can be about 10 μm to about 100 μm, for example.

A nonaqueous electrolyte secondary battery according to a second aspect of the present invention includes: an electrode assembly including a positive electrode, a negative electrode, and a separator disposed between the positive and negative electrodes; and a nonaqueous electrolyte impregnated into the electrode assembly. In this aspect of the present invention, the negative electrode is composed of the negative electrode for the nonaqueous electrolyte secondary battery according to the first aspect of the present invention. Therefore, the nonaqueous electrolyte secondary battery according to the second aspect of the present invention has a high capacity and an excellent high-temperature storage life.

In this aspect of the present invention, the types of the positive electrode, the separator, and the nonaqueous electrolyte are not particularly limited. For example, known types of positive electrodes, separators, and nonaqueous electrolytes can be used.

The positive electrode generally includes: a positive-electrode current collector composed of a piece of electrically conductive metal foil; and a positive electrode mixture layer formed on the positive-electrode current collector. The positive electrode mixture layer contains a positive-electrode active material. The positive-electrode active material is not particularly limited so long as lithium can be electrochemically inserted into and extracted from it. Specific examples of the positive-electrode active material include lithium composite oxides containing cobalt or manganese, such as lithium cobalt-nickel-manganese composite oxides, lithium nickel-manganese-aluminum composite oxides, and lithium nickel-cobalt-aluminum composite oxides, and olivine lithium phosphates, such as lithium iron phosphate (LiFePO₄).

The solvent for use in the nonaqueous electrolyte is not particularly limited. Specific examples of the solvent for use in the nonaqueous electrolyte include cyclic carbonates, such as ethylene carbonate, propylene carbonate, butylene carbonate, and fluoroethylene carbonate, chain carbonates, such as dimethyl carbonate, methyl ethyl carbonate, and diethyl carbonate, and mixture solvents of a cyclic carbonate and a chain carbonate.

The solute for use in the nonaqueous electrolyte is also not particularly limited. Specific examples of the solute for use in the nonaqueous electrolyte include LiPF₆, LiBF₄, LiCF₃SO₃, LiN(CF₃SO₂)₂, LiN(C₂F₅SO₂)₂, LiN(CF₃SO₂) (C₄F₉SO₂), LiC(CF₃SO₂)₃, LiC(C₂F₅SO₂)₃, LiPF₆₋ₓ(CₙF₂ₙ₊₁)ₓ where 1<x<6 and n=1 or 2, and mixtures of them. Examples of the electrolyte that can be used include gel polymer electrolytes in which a polymer electrolyte, such as polyethylene oxide or polyacrylonitrile, is impregnated with an electrolytic solution, and inorganic solid electrolytes, such as LiI and Li₃N.

The nonaqueous electrolyte preferably contains CO₂.

### BRIEF DESCRIPTION OF THE DRAWINGS

FIG. 1 is a schematic cross-sectional view of a nonaqueous electrolyte secondary battery produced in Example 1.

FIG. 2 is an enlarged schematic cross-sectional view of part of a negative electrode produced in Example 1.

### DETAILED DESCRIPTION

Hereinafter, the present invention will be described in more detail with reference to specific examples. However, the present invention is not limited at all by the following examples and can be embodied in various other forms appropriately modified without changing the spirit of the invention.

### Example 1

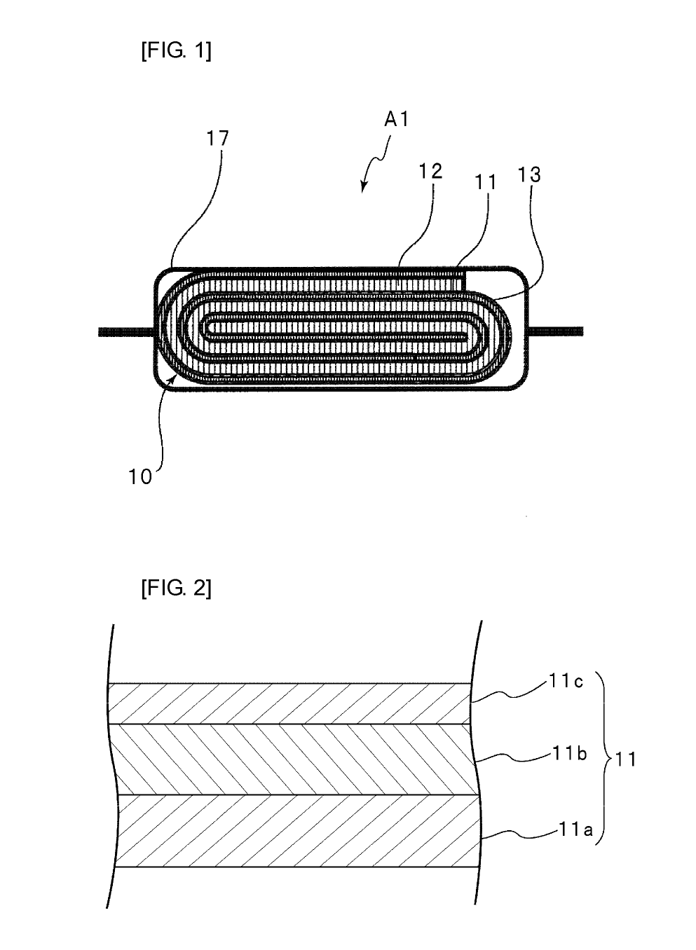

In this example, a nonaqueous electrolyte secondary battery A1 shown in FIG. 1 was produced in the following manner.

[Production of Positive Electrode]

Lithium cobaltate as a positive-electrode active material, acetylene black as a conductive carbon material, and poly(vinylidene fluoride) (PVdF) as a binder were added to N-methyl-2-pyrrolidone (NMP) as a dispersion medium to give a mass ratio of 95:2.5:2.5. Thereafter, the mixture was stirred using a kneader “COMBI MIX®” manufactured by PRIMIX Corporation to prepare a slurry for a positive electrode mixture. The slurry for a positive electrode mixture was applied to both sides of a piece of aluminum foil serving as a positive-electrode current collector, dried and rolled. Finally, a terminal was attached to the positive-electrode current collector to produce a positive electrode 12. The packing density in the positive electrode 12 was 3.7 g/cc.

[Production of Negative Electrode]

A 1.0% by mass carboxymethyl cellulose (CMC) aqueous solution was prepared by dissolving CMC (Grade 1380 manufactured by Daicel Chemical Industries, Ltd.) in deionized water using a homomixer manufactured by PRIMIX Corporation.

Next, 980 g of artificial graphite (average particle size: 21 μm, surface area: 4.0 m²/g) and 1250 g of the CMC aqueous solution were mixed, using a kneader “HIVIS MIX®” manufactured by PRIMIX Corporation, at 50 rpm for 60 minutes. Thereafter, deionized water was added to the mixture for the purpose of viscosity control and the mixture was then further mixed at 50 rpm for 10 minutes using the same kneader. Then, 20 g of styrene-butadiene rubber (SBR, solid content concentration: 50% by mass) was further added to the mixture and the mixture was mixed at 30 rpm for 45 minutes using the same kneader to prepare a graphite slurry. The mass ratio of artificial graphite to CMC to SBR in the obtained graphite slurry was 98.0:1.0:1.0.

Next, 920 g of lithium titanate (Li4Ti5O12, average particle size: 21 μm, surface area: 3.0 m²/g), 50 g of acetylene black, and 1250 g of the CMC aqueous solution were mixed, using a kneader “HIVIS MIX®” manufactured by PRIMIX Corporation, at 50 rpm for 60 minutes. Thereafter, deionized water was further added to the mixture for the purpose of viscosity control and the mixture was then further mixed at 50 rpm for 10 minutes using the same kneader.

Then, 20 g of SBR (solid content concentration: 50% by mass) was further added to the mixture and the mixture was mixed at 30 rpm for 45 minutes using the same kneader to prepare a lithium titanate slurry. The mass ratio of lithium titanate to acetylene black to CMC to SBR in the obtained lithium titanate slurry was 92.0:5.0:1.0:1.0.

Next, the graphite slurry was coated on a piece of copper foil 11a (see FIG. 2) serving as a negative-electrode current collector, dried and rolled to form a first negative-electrode active material layer 11b on the piece of copper foil 11a.

Next, the lithium titanate slurry was coated on the first negative-electrode active material layer 11b, dried and rolled to form a second negative-electrode active material layer 11c thereon. Finally, a terminal was attached to the current collector to produce a negative electrode 11.

The capacity ratio between opposed areas of the negative and positive electrodes was controlled to be 1.10 so that the negative electrode was richer in capacity. The mass ratio of graphite to lithium titanate (Graphite to lithium titanate) was selected to be 90:10. The thickness of the first negative-electrode active material layer 11b was 98 μm, while the thickness of the second negative-electrode active material layer 11c was 31 μm.

[Preparation of Nonaqueous Electrolytic Solution]

Ethylene carbonate (EC) and diethyl carbonate (DEC) were mixed to give an EC to DEC volume ratio of 3:7. Dissolved in the resultant mixture solvent was lithium hexafluorophosphate (LiPF₆) to reach a concentration of 1 mol/L, thereby preparing a nonaqueous electrolytic solution.

[Production of Electrode Assembly]

A single positive electrode 12, a single negative electrode 11, and two separators 13 were wound up with the positive electrode 12 and negative electrode 11 facing each other across each separator 13 interposed therebetween to produce an electrode assembly 10.

[Production of Battery]

The electrode assembly 10 and the nonaqueous electrolytic solution were introduced into a battery outer package 17 made of an aluminum laminate and sealed to produce a battery T1 of Example 1. The design capacity of the battery T1 was 75 mAh.

### Example 2

A battery T2 of Example 2 was produced in the same manner as in Example 1 except that the mass ratio of graphite to lithium titanate (Graphite to lithium titanate) was selected to be 95:5.

### Example 3

In this example, a lithium titanate slurry was prepared so that the mass ratio of lithium titanate to acetylene black to PVdF (lithium titanate to acetylene black to PVdF) in the resultant slurry was 92:4:3. Furthermore, in preparing the lithium titanate slurry, N-methyl-2-pyrrolidone (NMP) was used as a solvent. A battery T3 of Example 3 was produced in the same manner as in Example 2 except for the above.

### Comparative Example 1

A battery R1 of Comparative Example 1 was produced in the same manner as in Example 1 except that a second negative-electrode active material layer 11c was formed on a piece of copper foil 11a and a first negative-electrode active material layer 11b was formed on the second negative-electrode active material layer 11c.

In Comparative Example 1, the thickness of the first negative-electrode active material layer 11c was 98 μm. The thickness of the second negative-electrode active material layer 11b was 30 μm.

### Comparative Example 2

A battery R2 of Comparative Example 2 was produced in the same manner as in Example 1 except for a difference in the method for producing a negative electrode.

Specifically, in Comparative Example 2, the graphite slurry and lithium titanate slurry prepared in Example 1 were mixed to give a graphite to lithium titanate mass ratio (Graphite to lithium titanate) of 90:10, thereby preparing a slurry. The obtained slurry was coated on a piece of copper foil 11a having the same configuration as that used in Example 1, dried and rolled to produce a negative electrode. The thickness of the negative-electrode active material layer of the obtained negative electrode was 128 μm.

### Comparative Example 3

A battery R3 of Comparative Example 3 was produced in the same manner as in Example 1 except that no second negative-electrode active material layer was formed and only a first negative-electrode active material layer of 110 μm thickness was formed.

(Evaluation of Load Characteristics)

Each of the produced batteries T1 to T3 and R1 to R3 was first charged with a constant current of 1 It (75 mA) to a voltage of 4.2 V and then charged with a constant voltage of 4.2 V to a current of 1/20 It (3.75 mA). Thereafter, the battery was discharged with a constant current of 1 It (75 mA) to a voltage of 2.75 V and the discharge capacity at that time (1-It discharge capacity) was measured.

Thereafter, the battery was allowed to stand for 10 minutes, charged with a constant current of 1 It (75 mA) to a voltage of 4.2 V and then charged with a constant voltage of 4.2 V to a current of 1/20 It (3.75 mA). Then, the battery was discharged with a constant current of 2 It (150 mA) to a voltage of 2.75 V and the discharge capacity at that time (2-It discharge capacity) was measured.

Thereafter, the battery was allowed to stand for 10 minutes, charged with a constant current of 1 It (75 mA) to a voltage of 4.2 V and then charged with a constant voltage of 4.2 V to a current of 1/20 It (3.75 mA). Then, the battery was discharged with a constant current of 3 It (225 mA) to a voltage of 2.75 V and the discharge capacity at that time (3-It discharge capacity) was measured.

The proportion of 2-It discharge capacity to 1-It discharge capacity (2C/1C) and the proportion of 3-It discharge capacity to 1-It discharge capacity (3C/1C) are shown in TABLE 1 below.

(Evaluation of High-Temperature Storage Life)

Each of the produced batteries T1 to T3 and R1 to R3 was first charged with a constant current of 1 It (75 mA) to a voltage of 4.2 V and then charged with a constant voltage of 4.2 V to a current of 1/20 It (3.75 mA). Then, the battery was allowed to stand at 80° C. for two days. Next, the battery was cooled down to room temperature and discharged with a constant current of 1 It (75 mA) to a voltage of 2.75 V. Then, the remaining capacity rate after the above storage test was calculated based on the following equation (1):

Remaining capacity rate(%)={(first discharge capacity after storage test)/(discharge capacity before storage test)}×100 (1)

Thereafter, the battery was charged again with a constant current of 1 It (75 mA) to a voltage of 4.2 V and then charged with a constant voltage of 4.2 V to a current of 1/20 It (3.75 mA). Then, the battery was discharged with a constant current of 1 It (75 mA) to a voltage of 2.75 V (subjected to a second constant-current discharge after the storage test). Then, the recovery capacity rate was calculated based on the following equation (2). The results are shown in TABLE 2 below.

Recovery capacity rate(%)={(second discharge capacity after storage test)/(discharge capacity before storage test)}×100 (2)

TABLE 1

| | Graphite to Lithium titanate | | 2C/1C | 3C/1C |
|---|---|---|---|---|
| Battery | (Mass Ratio) | Negative-electrode Active Material Layer | (%) | (%) |
| Battery T1 | 90:10 | Lithium titanate/Graphite/Current collector | 70 | 38 |
| Battery T2 | 95:5 | Lithium titanate/Graphite/Current collector | 71 | 38 |
| Battery T3 | 95:5 | Lithium titanate/Graphite/Current collector | 69 | 36 |
| Battery R1 | 90:10 | Graphite/Lithium titanate/Current collector | 41 | 7 |
| Battery R2 | 90:10 | (Graphite + Lithium titanate)/Current collector | 56 | 21 |
| Battery R3 | 100:0 | Graphite/Current collector | 69 | 35 |

TABLE 2

| | | | Remaining | Recovery |
|---|---|---|---|---|
| | Graphite to Lithium titanate | | Capacity | Capacity |
| Battery | (Mass Ratio) | Negative-electrode Active Material Layer | Rate (%) | Rate (%) |
| Battery T1 | 90:10 | Lithium titanate/Graphite/Current collector | 85 | 89 |
| Battery T2 | 95:5 | Lithium titanate/Graphite/Current collector | 85 | 89 |
| Battery T3 | 95:5 | Lithium titanate/Graphite/Current collector | 84 | 90 |
| Battery R1 | 90:10 | Graphite/Lithium titanate/Current collector | 39 | 68 |
| Battery R2 | 90:10 | (Graphite + Lithium titanate)/Current collector | 68 | 82 |
| Battery R3 | 100:0 | Graphite/Current collector | 81 | 90 |

As shown in TABLE 1, in terms of the load characteristics (i.e., 2C/1C and 3C/1C), the battery R3 in which only a negative-electrode active material layer containing graphite was formed on the negative-electrode current collector was substantially comparable to the batteries T1 to T3 in which a second negative-electrode active material layer containing lithium titanate was formed on a first negative-electrode active material layer containing graphite. Furthermore, as shown in TABLE 2, the battery R3 was also substantially comparable in recovery capacity rate to the batteries T1 to T3. On the other hand, as for remaining capacity rate, the batteries T1 to T3 were higher than the battery R3. These results reveal that the formation of a second negative-electrode active material layer containing lithium titanate on a first negative-electrode active material layer containing graphite can improve the high-temperature storage life without deteriorating the load characteristics.

On the other hand, the battery R1, in which a negative-electrode active material layer containing lithium titanate was formed on a negative-electrode current collector and a negative-electrode active material layer containing graphite was formed on the first-mentioned negative-electrode active material layer, exhibited worse results than the battery R3 in terms of all of the load characteristics, the remaining capacity rate and the recovery capacity rate. This shows that if a negative-electrode active material layer containing lithium titanate is formed and a negative-electrode active material layer containing graphite is formed on the first-mentioned negative-electrode active material layer, the above-mentioned effect of improving the high-temperature storage life cannot be obtained.

The reason for the poor load characteristics of the battery R1 can be attributed to the fact that since the lithium titanate-containing negative-electrode active material layer requiring a high potential for lithium ion insertion and extraction was located directly on top of the negative-electrode current collector, the electric resistance of the entire negative electrode was increased to inhibit lithium ions from being inserted into and extracted from graphite.

Furthermore, the battery R2, in which a negative-electrode active material layer containing a mixture of graphite and lithium titanate was formed, also exhibited worse results than the battery R3 in terms of all of the load characteristics, the remaining capacity rate and the recovery capacity rate. This shows that if a negative-electrode active material layer containing a mixture of lithium titanate and graphite is formed, the above-mentioned effect of improving the high-temperature storage life cannot be obtained.

What is claimed is:

1. A negative electrode for a nonaqueous electrolyte secondary battery, comprising:
a negative-electrode current collector;
a first negative-electrode active material layer formed on the negative-electrode current collector and containing graphite as a first negative-electrode active material; and
a second negative-electrode active material layer formed on the first negative-electrode active material layer and containing a lithium titanate composite oxide as a second negative-electrode active material.

2. The negative electrode for the nonaqueous electrolyte secondary battery according to claim 1, wherein the thickness of the first negative-electrode active material layer is greater than that of the second negative-electrode active material layer.

3. The negative electrode for the nonaqueous electrolyte secondary battery according to claim 1, wherein the content of the lithium titanate composite oxide in the total amount of the graphite and the lithium titanate composite oxide ((lithium titanate composite oxide)/(graphite+lithium titanate composite oxide)) is 10% by mass or less.

4. The negative electrode for the nonaqueous electrolyte secondary battery according to claim 1, wherein the first and second negative-electrode active material layers contain different types of binders.

5. The negative electrode for the nonaqueous electrolyte secondary battery according to claim 4, wherein
the first negative-electrode active material layer contains a latex resin as the binder, and
the second negative-electrode active material layer contains poly(vinylidene fluoride) as the binder.

6. The negative electrode for the nonaqueous electrolyte secondary battery according to claim 1, wherein the lithium titanate composite oxide is spinel lithium titanate Li₄Ti₅O₁₂.

7. A nonaqueous electrolyte secondary battery comprising:
an electrode assembly including the negative electrode for the nonaqueous electrolyte secondary battery according to claim 1, a positive electrode, and a separator disposed between the positive electrode and the negative electrode; and
a nonaqueous electrolyte impregnated into the electrode assembly.

8. A nonaqueous electrolyte secondary battery comprising:
an electrode assembly including the negative electrode for the nonaqueous electrolyte secondary battery according to claim 2, a positive electrode, and a separator disposed between the positive electrode and the negative electrode; and
a nonaqueous electrolyte impregnated into the electrode assembly.

9. A nonaqueous electrolyte secondary battery comprising:
an electrode assembly including the negative electrode for the nonaqueous electrolyte secondary battery according to claim 3, a positive electrode, and a separator disposed between the positive electrode and the negative electrode; and
a nonaqueous electrolyte impregnated into the electrode assembly.

10. A nonaqueous electrolyte secondary battery comprising:
an electrode assembly including the negative electrode for the nonaqueous electrolyte secondary battery according to claim 4, a positive electrode, and a separator disposed between the positive electrode and the negative electrode; and
a nonaqueous electrolyte impregnated into the electrode assembly.

11. A nonaqueous electrolyte secondary battery comprising:
an electrode assembly including the negative electrode for the nonaqueous electrolyte secondary battery according to claim 5, a positive electrode, and a separator disposed between the positive electrode and the negative electrode; and
a nonaqueous electrolyte impregnated into the electrode assembly.

12. A nonaqueous electrolyte secondary battery comprising:
an electrode assembly including the negative electrode for the nonaqueous electrolyte secondary battery according to claim 6, a positive electrode, and a separator disposed between the positive electrode and the negative electrode; and
a nonaqueous electrolyte impregnated into the electrode assembly.
